(19) United States
(12) Patent Application Publication
(10) Pub. No.: US 2015/0379896 A1
(43) Pub. Date: Dec. 31, 2015

(54) INTELLIGENT EYEWEAR AND CONTROL METHOD THEREOF

(71) Applicants: BOE Technology Group Co., Ltd., Beijing (CN); BEIJING BOE OPTOELECTRONICS TECHNOLOGY CO., LTD., Beijing (CN)

(72) Inventors: Jiuxia Yang, Beijing (CN); Feng Bai, Beijing (CN); Bing Bai, Beijing (CN)

(21) Appl. No.: 14/417,440

(22) PCT Filed: Jun. 30, 2014
(86) PCT No.: PCT/CN2014/081282

§ 371 Date: Jan. 26, 2015

(30) Foreign Application Priority Data
Dec. 5, 2013 (CN) 201310652206.8

(51) Int. Cl. G09B 21/00; G06F 3/01; G02B 27/01

(52) U.S. Cl. CPC G09B 21/009; G02B 27/017; G06F 3/015; G06F 3/017; G02B 2027/0178

(57) ABSTRACT

An intelligent eyewear and a control method thereof are provided, and the intelligent eyewear includes an eyeglass, an eyeglass frame and a leg. The eyeglass includes a transparent display device for two-side display; the eyeglass frame is provided with a camera and an acoustic pickup, which are configured to acquire a gesture instruction and a voice signal respectively; and the leg is provided with a brainwave recognizer and a processor, the brainwave recognizer is configured to acquire a brainwave signal, and the processor is configured to receive and process the gesture instruction, the voice signal and the brainwave signal. The intelligent eyewear can convert information from outside into graphic and textual information visible to a wearer of the eyewear, and can further present what the wearer is not able to express in voice to others by means of graph and text.

### TECHNICAL FIELD

Embodiments of the present disclosure relate to an intelligent eyewear and a control method thereof.

### BACKGROUND

Since deaf and dumb persons are unable to hear and/or speak due to their own physiological defects, they can not learn about thoughts of others and can not communicate with others by language. This causes great inconvenience in their daily life. Most deaf and dumb persons are able to express what they want to say in sign language, but they can not achieve good communication with a person having no idea of sign language. Persons with a hearing disorder may wear hearing aids to overcome their hearing defect. The hearing aids help to alleviate the hearing defect of persons with a hearing disorder, but still have some limitations. For example, it can not be guaranteed that everyone with a hearing disorder will obtain the same hearing as that of the ordinary person by hearing aids, and as a result some persons with a hearing disorder may still have difficulty in hearing what other people says.

### SUMMARY

According to at least one embodiment of the present disclosure, an intelligent eyewear is provided, and the intelligent eyewear includes an eyeglass, an eyeglass frame and a leg. The eyeglass comprises a transparent display device configured to perform two-side display; the eyeglass frame is provided with a camera and an acoustic pickup, which are configured to acquire a gesture instruction and a voice signal and convert them into a gesture signal and an audio signal respectively; and the leg is provided with a brainwave recognizer and a processor, the brainwave recognizer is configured to acquire a brainwave signal of a wearer and the processor is configured to receive and process the gesture signal, the audio signal and the brainwave signal and send a processed result to the transparent display device for the two-side display.

In an example, the processor is configured to generate the processed result in a form of graphic and textual information.

In an example, for each eyeglass, the transparent display device includes a display device with two display surfaces, which are configured for front-face display and back-face display respectively.

In an example, for each eyeglass, the transparent display device includes two display devices each of which has one display surface, and the display devices are configured for front-face display and back-face display respectively.

In an example, the transparent display device is a flexible display device.

In an example, the intelligent eyewear further comprises an analysis memory which is connected with the processor and has at least one of the following databases stored therein: a database including a correspondence relationship between the brainwave signal and content indicated by the brainwave signal, a database including a correspondence relationship between the gesture signal and content indicated by the gesture signal, and a database including a correspondence relationship between the audio signal and content indicated by them.

In an example, the intelligent eyewear further comprises a positioning system; the camera is further configured to acquire environmental information of an ambient environment of the intelligent eyewear and send it to the processor, and the processor is further configured to locate the wearer according to the environmental information the camera sends in combination with the positioning system.

In an example, the acoustic pickup is disposed at a position where a nose pad of the eyeglass frame is located, the brainwave recognizer is disposed in a middle of the leg, and the processor is disposed at a tail end of the leg.

In an example, the positioning system comprises a memory with location information pre-stored therein.

In an example, the positioning system includes a distance meter disposed on the leg and configured to sense a distance between a current location and a target location and send a sensed result to the processor.

In an example, a data transmission device configured for data transmission to and from an external device is further disposed on the leg.

In an example, the leg further comprises a charging device, which is configured for charging at least one of the transparent display device, the camera, the acoustic pickup, the brainwave recognizer and the processor.

In an example, the charging device is a solar charging device integrated on a surface of the eyeglass.

In an example, the distance meter is one selected from the group consisting of an ultrasonic range finder, an infrared distancer and a laser range finder.

According to at least one embodiment of the present disclosure, a method for controlling the above-mentioned intelligent eyewear is further provided, and the method comprises the following receiving mode and expression mode which may be performed one after another, simultaneously or independently.

For example, the receiving mode comprises: S1.1 by means of the camera and the acoustic pickup, acquiring a gesture instruction and a voice signal of a communicatee, converting them into a gesture signal and an audio signal, and sending the gesture signal and the audio signal to the processor; and S1.2 by means of the processor, recognizing the audio signal and the gesture signal separately to convert them into graphic and textual information and performing back-face display through the eyeglass to display the information to a wearer.

For example, the expression mode comprises: S2.1 by means of the brainwave recognizer, acquiring a brainwave signal of the wearer, obtaining a first information by encoding and decoding the brainwave signal, and sending the first information to the processor; and S2.2 by means of the processor, converting the first information into graphic and textual information and performing front-display through the eyeglass to display the graphic and textual information to the communicatee.

In an example, step S1.2 comprises: by means of the processor, performing searching and matching of the received gesture and audio signals in a database with a correspondence relationship between the gesture signal and content indicated by the gesture signal stored therein and in a database with a correspondence relationship between the audio signal and content indicated by the audio signal stored therein, and outputting indicated contents in a form of graph and text.

In an example, if step 2.1 fails to acquire the brainwave signal, the method may further comprise reminding an occurrence of an error through the back-face display of the eyeglass.

In an example, step S2.2 comprises: by means of the processor, performing searching and matching of the received first information in a database with a correspondence relationship between the brainwave information and content indicated by it stored therein, and outputting indicated content in a form of graph and text.

In an example, before performing the front-face display, step S2.2 may further comprise: performing back-face display for the graphic and textual information, and then performing the front-face display for the graphic and textural information after receiving a brainwave signal indicating acknowledgement from the wearer.

In an example, in step S1.1, the audio signal is obtained by performing analog-to-digital conversion for the acquired voice signal by the acoustic pickup.

In an example, in step S1.1, information of an ambient environment is also acquired by the camera at a same time that the gesture signal and the audio signal are acquired, and is used to determine a current location in combination with a positioning system.

In an example, in step S1.1, calculation of and comparison between the environmental information acquired by the camera and location information stored in the positioning system are performed by the processor.

### BRIEF DESCRIPTION OF THE DRAWINGS

Embodiments of the present disclosure will be described in more detail below with reference to the accompanying drawings to enable those skilled in the art to understand the present disclosure more clearly.

FIG. 1 is a structure schematic view of an intelligent eyewear provided in an embodiment of the present disclosure;

FIG. 2 is a schematic diagram illustrating a principle of a recognizing and judging procedure in an expression mode of an intelligent eyewear provided in an embodiment of the present disclosure;

FIG. 3 is a schematic diagram illustrating a principle of a matching and judging procedure in an expression mode of an intelligent eyewear provided in an embodiment of the present disclosure;

FIG. 4 is a schematic diagram illustrating a principle in a receiving mode of an intelligent eyewear provided in an embodiment of the present disclosure; and

FIG. 5 is a flow chart illustrating steps of a method for controlling of an intelligent eyewear provided in an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. It is obvious that the embodiments to be described are only some illustrative ones, not all, of the embodiments of the present disclosure. Based on the described illustrative embodiments of the present disclosure, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Similarly, terms such as “one”, “a” or “the” do not mean to limit quantity but represent the presence of at least one. The terms “comprises,” “comprising,” “includes,” “including,” etc., are intended to specify that the elements or the objects stated before these terms encompass the elements or the objects and equivalents thereof listed after these terms, but do not preclude the other elements or objects. Terms “on,” “under,” and the like are only used to indicate relative position relationship, and when the absolute position of the object which is described is changed, the relative position relationship may be changed accordingly.

Specific implementations of the present disclosure will be described further in detail hereinafter in such a way that some features and structures are omitted to make the description more clear. The way is not intended that only the described features and structures are included, but that other needed features and structures may also be included.

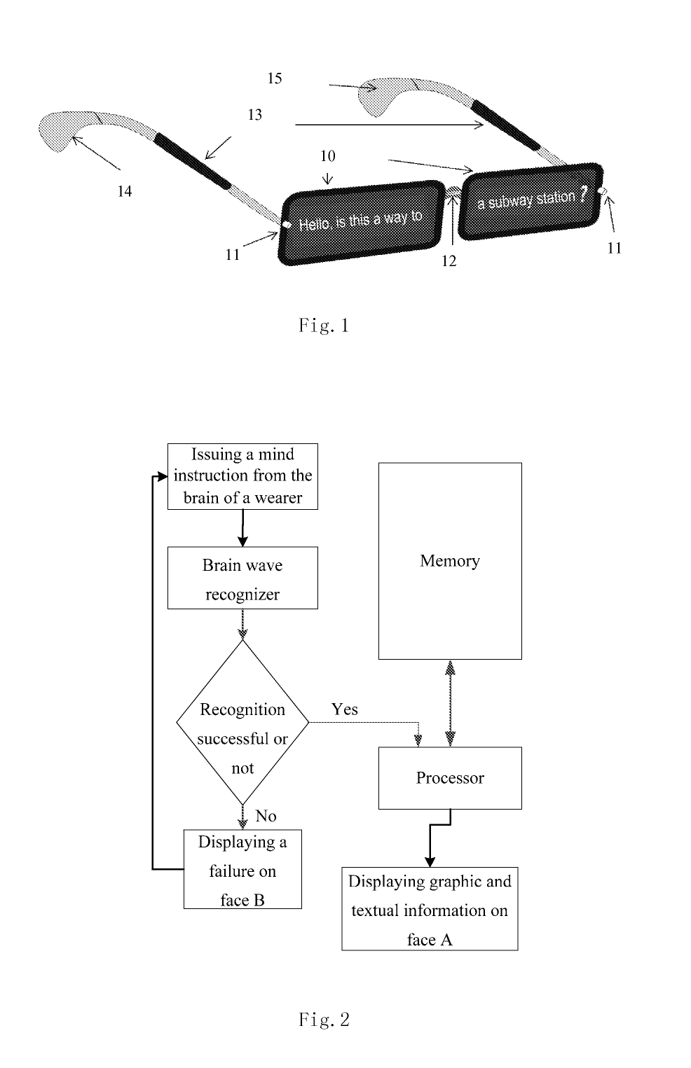

A structure of an intelligent eyewear in an embodiment of the present disclosure is illustrated in FIG. 1, and the intelligent eyewear includes an eyeglass, an eyeglass frame and a leg.

The eyeglass includes a transparent display device 10 configured for two-side display. The eyeglass frame is equipped with at least one camera 11 and an acoustic pickup 12, which are configured to acquire gesture instructions and voice signals and, if needed, can further convert them into gesture signals and audio signals respectively. The leg is equipped with a brainwave recognizer 13 and a processor 14, the brainwave recognizer 13 is configured to acquire brainwave signals of a wearer, and the processor 14 is configured to receive and process the gesture signals, audio signals and brainwave signals and send processed results to the transparent display device for the two-side display.

It is to be noted that, in the embodiment shown in FIG. 1, the processor 14 is provided inside the tail end of the leg on one side; and in other embodiments, modules with other functions, such as a built-in communication module for WIFI or Bluetooth, a GPS location module or the like, may be provided inside the tail end of the leg on the other side.

In an embodiment of the present disclosure, the transparent display device 10 is configured to display the graphic and textual information processed by the processor 14 on its both sides.

In a first example for implementing the two-side display, the transparent display 10 includes a display device with two display surfaces, and the two display surfaces are used for front-face display and back-face display respectively. In a second example for implementing the two-side display, the transparent display device 10 includes two display devices each having one display surface and therefore has two display surfaces in all, which are used for front-face display and back-face display respectively.

It is to be noted that, in embodiments of the present disclosure, the front-face display and back-face display mean two display modes. In fact, opposite display contents may be observed simultaneously on both sides of the eyeglass during display process, no matter which display mode is on, since the display device is a transparent display device. The above-mentioned second example is different from the first example described above in the number of the employed display device(s), which will be explained as follows. In the first example, each eyeglass employs a display device with two display surfaces, the display device is transparent in itself, and the transparent display device has two display surfaces corresponding to face A and face B of the eyeglass respectively and being used for back-face display mode and front-face display mode respectively; and in the second example, each eyeglass adopts two display devices arranged back to back, i.e. each eyeglass consists of two display devices, which correspond to face A and face B of the eyeglass respectively and also are used for the two modes, back-face display and front-face display, respectively. It is to be noted that all the above descriptions for the transparent display device is directed against the structure of one of the two pieces of eyeglass and both of the two pieces of eyeglass may have the same structure.

In an embodiment of the present disclosure, the above-mentioned front-face display mode and the back-face display mode are expression mode and receiving mode respectively. In the expression mode, thoughts or ideas of a wearer are presented to an ordinary person in front of the wearer through the eyeglass of the eyewear, and in the receiving mode, information such as voices and gestures of the ordinary person in front of the wearer is acquired and in the end conveyed to the wearer through the eyeglass. Generally, in the expression mode, a front face of the intelligent eyewear is used for displaying and the so called front face is the face (supposed to be face A) in the direction of the sight line of the wearer and thus presented to an ordinary person in front of the wearer; and in the receiving mode, a back face of the intelligent eyewear is used for displaying and the so called back face is the face (supposed to be face B) in the direction opposite to that of the sight line of the wearer and thus presented to the wearer.

In an embodiment of the present disclosure, the eyeglass employs a flexible display device to achieve a curved structure design for the eyeglass. In an example for this, the display areas in the eyeglass frame are curved so as to extend to the lateral sides of the head of a user in order that not only prompting pictures are shown in front of the user, but also graphic and textual information is shown in the display areas on the left and right sides, when images are displayed on the eyeglass of the eyewear.

In at least one embodiment of the present disclosure, the graphic and textual information includes one or more types of information selected from the group consisting of text information, picture information and combinations thereof.

In an embodiment of the present disclosure, a camera 11 is disposed on the eyeglass frame to acquire gesture instructions, generate gesture signals and send the gesture signals to the processor 14. In an example, cameras 11 are located right ahead of the intelligent eyewear on both of the left and right sides so as to achieve omnibearing observations on the surroundings of the wearer.

In an embodiment of the present disclosure, the camera 11 is not only used to acquire gesture instructions of other persons in front of the wearer to learn about their thoughts and intents, but also used to acquire and detect information related to surroundings and conditions around the wearer in real time and send the corresponding information to the processor 14 where the information is processed and inference and calculation are executed according to internal database to determine the exact location of the wearer based on the results in combination with, for example, a GPS positioning system.

In an embodiment of the present disclosure, a positioning system of the intelligent eyewear includes a GPS localizer and a memory with environmental information pre-stored therein, which are connected to the processor 14 respectively. At this point, the camera 11 is configured to monitor the surrounding environment of the intelligent eyewear, acquire information of the surrounding environment, and send the environmental information to the processor 14, which executes comparison between and calculation of the environmental information and that pre-stored in the database in the memory and determines the current location to obtain a positioning information. The positioning information obtained in such a way helps other intelligent terminals determine the location of the wearer according to the location information, so as to provide the wearer with optimal routes for nearby places, for example, providing the wearer with the nearest subway station, the shortest route from the current location to the subway station, and the like; and, for example, other helpful information can be obtained according to the location information with the same principle as above and thus detailed descriptions are omitted herein.

In an embodiment of the present disclosure, the positioning system further includes a distance meter to sense the distance between the current location and a target location. In an example, the distance meter is built into the eyeglass frame and has the function of measuring in real time the distance between the wearer and the road sign of the location where the wearer is, so as to realize accurate positioning. In another embodiment, the distance meter measures the distance between the wearer and the communicatee, according to the distance, orientation and pickup distance of the acoustic pickup 12 is set. In an example, the distance meter is one selected from the group consisting of an ultrasonic range finder, an infrared distancer and a laser range finder.

In an embodiment of the present disclosure, the acoustic pickup 12 is disposed at a position where a nose pad of the eyeglass frame is located, the brainwave recognizer 13 is disposed in the middle of the leg, and the processor 14 is disposed at the tail end of the leg. In an embodiment of the present disclosure, the acoustic pickup 12 picks up voice signals (e.g. analog signals) within a certain range, converts them into digital signals, and then sends them to the processor 14 where they are converted to graphic and textural information by means of speech recognition and sent to the transparent display device 10 to be displayed by the back face of the eyeglass of the eyewear.

In an embodiment of the present disclosure, the brainwave recognizer 13 is disposed in the middle of the leg and very close to the brain of the wearer when the intelligent eyewear is worn. Brainwave signals may be generated when ideas or thoughts occur to human brains, and the brainwave recognizer 13 is used to identify the brainwave signals, read the information (i.e. operating instructions) in the brainwaves as the wearer is thinking, and, obtains a first information by means of decoding and encoding, and sends the first information to the processor 14 by which the first information is analyzed and processed and then displayed to the communicatee of the wearer in the form of graphic and textual information on the face A.

With regard to the brainwave recognition described above, in an example, the intelligent eyewear includes an analysis memory which includes a database with correspondence relationships between brainwave information (the first information) and graphic and textual information representing ideas and thoughts of the signal sender (i.e. contents indicated by the signals) stored therein. Based on the first information received, the processor determines the corresponding content indicated by the current brainwave signal through lookup and comparison in the database and makes the content to be displayed.

In an embodiment of the present disclosure, a data transmission device and a charging device are further disposed in the leg. The data transmission device is used for data transmission to and from external devices. The charging device is used for charging at least one of the transparent display device 10, the camera 11, the acoustic pickup 12, the brainwave recognizer 13 and the processor 14 to enhance the endurance of the intelligent eyewear.

In an example, the charging device is a solar charging device and integrated on surfaces on both sides of the eyeglass.

In an example, the data transmission device is disposed inside the tail end of the leg on the other side and without the processor 14.

In an example, the communication function of the intelligent eyewear provided in embodiments of the present disclosure is implemented by the data transmission device, that is, communication with the wearer of the intelligent eyewear provided in the present embodiment is implemented by means of a RF (Radio Frequency) system. For example, after processed by a processing unit and an artificial intelligence system correspondingly, voice information from users of other intelligent terminals is conveyed to the user in the display mode with face B through the display. Responses from the user are emitted through brainwaves and converted into graphic and textural information after recognized and read. The graphic and textural information is displayed on the eyeglass in the display mode with face B to wait for acknowledgement for its contents from the user. After the processor 14 receives the acknowledgement from the wearer, the graphic and textual information is conveyed to the communicatee in the display mode with face A, or converted into voice signals by, for example, the processor, and then sent out by the data transmission device.

In an embodiment of present disclosure, the communication function is implemented by means of WIFI, Bluetooth or the like. Therefore, in an example, the intelligent eyewear is further configured with an entertainment function, so that by means of brainwaves, the wearer can play games through the eyeglass, surf the internet with WIFI, or make data transmission to and from other devices.

In an embodiment of the present disclosure, the operating principle in the expression mode of the intelligent eyewear will be described as follows.

A mind instruction is issued from the brain of the wearer and generates a brainwave signal which is recognized by the brainwave recognizer 13. A term “Fail to recognize” will be displayed on face B of the transparent display device 10 if the brainwave recognizer 13 fails to recognize the brainwave signal. After receiving the feedback in the form of term “Fail to recognize” through the face B, the wearer reproduces a brainwave signal. This is the recognizing and judging procedure used to feed back an error during the information reading of the brainwave recognizer. The principle is shown in the schematic diagram in FIG. 2.

Furthermore, after recognizing the brainwave signal successfully, the brainwave recognizer 13 compares the recognized signal with those stored in the brainwave database in the memory, for example, performing matching between the recognized signal and information codes in the brainwave database and determines whether the comparison is passed based on the matching degree. If the comparison is passed, it indicates a successful reading for the brainwaves, and the first information is obtained through a decoding and encoding process and sent to the processor 14, which continues to analyze and process the information, for example, to perform searching and matching based on the database that is pre-stored in the analysis memory and includes correspondence relationships between brainwave signals and graphic and textual information, and to output the matched graphic and textual information, i.e. to display the information through face A of the transparent display device 10.

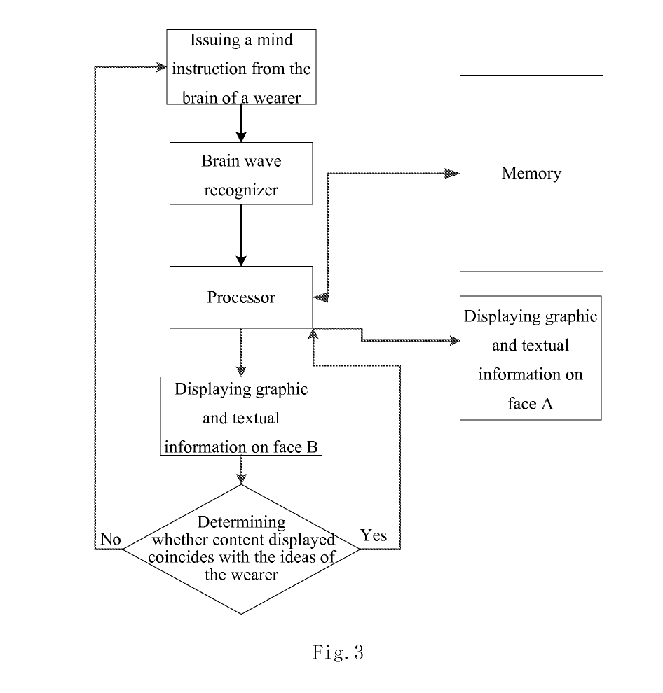

In an embodiment of the present disclosure, before displaying the graphic and textual information obtained by comparing and matching the brainwave signal with the database on face A, the information may be displayed on face B and presented to the wearer for judging. If the graphic and textual information coincides with the ideas of the wearer, he/she may produce an acknowledging brainwave signal, and the processor 14 receives the acknowledging information, and then controls the transparent display device to switch to the display mode with face A and display the matched graphic and textual information to others except for the wearer; and if the graphic and textual information displayed on face B does not coincide with the ideas of the wearer, the wearer may reproduce a new brainwave signal, the brainwave recognizer receives the brainwave signal emitted by the brain of the wearer again and repeats the above-mentioned operations along with the processor until the graphic and textual information coincides with the ideas of the wearer. This is the matching and judging procedure, i.e. determining whether the information output by the processor coincides with the ideas that the wearer wants to express. The principle is shown in the schematic diagram in FIG. 3. Through this judging procedure, the graphic and textual information processed by the processor may be displayed on face A of the eyewear if it fully coincides with the opinion of the wearer, but the wearer may reproduce the mind instruction if the information processed by the processor is different from what the wearer wants to express. Therefore, thoughts of the wearer can be expressed more exactly to realize useful and exact communications.

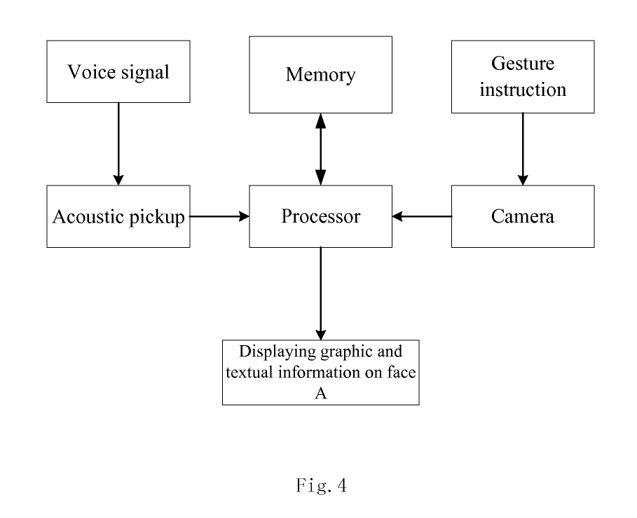

In an embodiment of the present disclosure, the operating principle in the receiving mode of the intelligent eyewear is shown in FIG. 4.

The camera 11 and the acoustic pickup 12 acquire gesture instructions and voice signals respectively and convert them into gesture signals and audio signals respectively, and then send them to the processor 14 to be processed. The processor 14 performs searching and matching in the database, which is stored in the analysis memory and includes the correspondence relationship between gesture signals and graphic and textural information and the correspondence relationship between audio signals and graphic and textural information, to determine ideas or intents that the gesture and voice signals of the ordinary person means to express to the wearer of the intelligent eyewear. The ideas or intents are displayed to the ordinary person in front of the wearer in the form of the graphic and textural information on face B of the transparent display device 10 to implement the process during that the wearer receives external information.

In an example, the acoustic pickup 12 converts voice signals into audio signals through analog to digital conversion, and the camera 11 converts gesture instructions into gesture signals through a decoder and an encoder in the processor.

As described above, at least one embodiment of the present disclosure provides an intelligent eyewear that facilitates communication between a deaf and dumb person wearing the intelligent eyewear and an ordinary person. Gesture instructions and voice signals issued to the wearer from the ordinary person are acquired by a camera and an acoustic pickup, and, after recognized and processed by the processor, are displayed to the wearer in the form of, for example, graphic and textual information on the back face of the eyeglass, so that the wearer can learn about thoughts and ideas of the ordinary person; and similarly, brainwave signals of the wearer are acquired by the brainwave recognizer and, after analyzed and processed by the processor, are displayed to the ordinary person in the form of, for example, corresponding graphic and textual information on the front face of the eyeglass, so that the ordinary person can learn about thoughts and ideas of the wearer. Thereby, the obstacle that deaf and dumb persons and ordinary persons cannot communicate well can be removed.

Embodiments of the present disclosure further provide a control method based on the intelligent eyewear in any one of the embodiments described above. The method includes steps S1-S2 for controlling the intelligent eyewear to perform the reception display and steps S3, S4 for controlling the intelligent eyewear to perform the expression display.

For example, the controlling steps for the reception display includes: S1. by means of a camera and an acoustic pickup, acquiring gesture instructions and voice signals of a communicatee, converting them into gesture signals and audio signals and sending the converted signals to a processor; and S2. by means of the processor, recognizing the audio signals and the gesture signals separately to convert them into graphic and textual information and displaying the information on the back face of the eyeglass.

For example, the controlling steps for the expression display includes: S3. by means of the brainwave recognizer, acquiring brainwave signals of a wearer, obtaining a first information by encoding and decoding of the brainwave signals, and sending the first information to the processor; and S4. by means of the processor, converting the first information into graphic and textual information and displaying it on the front face of the eyeglass.

It is to be noted that, in the reception control, S1 and S2 are performed one after another, and in the expression control, S3 and S4 are performed one after another; but the two sets of steps may be performed simultaneously, one after another, or independently.

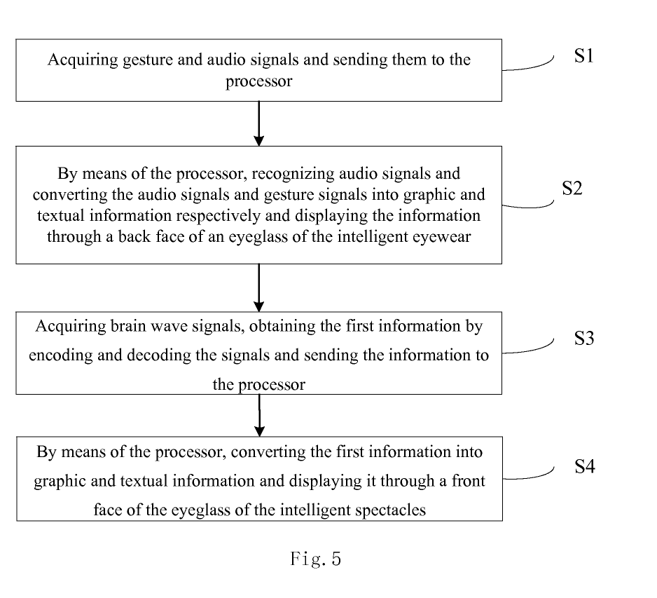

FIG. 5 shows a method for controlling an intelligent eyewear in an embodiment of the present disclosure, and in the method, the reception control is performed before the expression control (i.e. in the order of S1-S2-S3-S4). However, it is to be understood that in other embodiments there may only exist the reception control (performed in the order of S1-S2), or there may only exist the expression control (performed in the order of S3-S4), or the expression control may be performed before the reception control (i.e. in the order of S3-S4-S1-S2).

In an example, step S1 includes: by means of the processor, performing searching and matching of the received gesture and audio signals in the database with correspondence relationships between gesture signals and contents indicated by them stored therein and in the database with correspondence relationships between audio signals and contents indicated by them stored therein, and outputting the indicated contents in the form of graph and text.

In an example, if step S3 fails to acquire the brainwave signals, the method may further include: reminding an occurrence of an error through back-face display of the eyeglass.

In an example, step S4 includes: by means of the processor, performing searching and matching of the received first information in the database with correspondence relationships between brainwave information and contents indicated by it stored therein, and outputting the indicated contents in the form of graph and text.

In an example, before the displaying on the front face of the eyeglass of the intelligent eyewear, step S4 further includes: displaying the graphic and textual information on the back face of the eyeglass and then displaying it on the front face of the eyeglass after receiving brainwave signals indicating acknowledgement from the wearer.

In an example, in step S1, the audio signals are obtained by performing analog-to-digital conversion for the acquired voice signals by the acoustic pickup.

In an example, in step S1, information of an ambient environment is also acquired by the camera at a same time that the gesture and audio signals are acquired, and is used to determine a current location in combination with a positioning system.

In an example, in step S1, calculation of and comparison between the environmental information acquired by the camera and location information stored in the positioning system are performed by the processor.

In the method for controlling intelligent eyewear provided in an embodiment of the present disclosure, the descriptions of relevant functions of the above-mentioned intelligent eyewear may be referred to for the recognizing, reading, and matching of gesture signals, voice signals and brainwave signals, the generating, outputting, and front and back side displaying of the graphic and textual information, and implementations of other auxiliary function such as positioning of the wearer, data transmission to and form outside or the like.

In summary, in the control method provided in at least one embodiment of the present disclosure, by wearing the above-mentioned intelligent eyewear, communications between a wearer and the ordinary person around the wearer can be achieved mainly by means of acquisition and conversion of gesture instructions, voice signals and brainwave signals performed by cameras, and devices or modules for speech and brainwave recognition, by processing of the obtained signals performed by the processor, and by displaying the graphic and textual information arising from the processing. Since the intelligent eyewear includes a transparent display device for two-side display, good communications can be achieved between a deaf and dumb person and an ordinary one around his/her and accuracy of the existing means of expression such as sign language may be improved.

The above implementations are only used for describing the present disclosure and not limitative to the present disclosure. Those skilled in the art can further make various modifications and variations without departing from the spirit and scope of the present disclosure. Therefore all equivalents fall within the scope of the present disclosure and the scope of the present disclosure should be defined by claims.

The present application claims priority of China Patent Application No. 201310652206.8, filed on Dec. 5, 2013, which is entirely incorporated herein by reference.

1. An intelligent eyewear comprising an eyeglass, an eyeglass frame, and a leg;
wherein the eyeglass comprises a transparent display device configured to perform two-side display;
the eyeglass frame is provided with a camera and an acoustic pickup, which are configured to acquire a gesture instruction and a voice signal and convert them into a gesture signal and an audio signal respectively; and
the leg is provided with a brainwave recognizer and a processor, the brainwave recognizer is configured to acquire a brainwave signal of a wearer, and the processor is configured to receive and process the gesture signal, the audio signal and the brainwave signal and send a processed result to the transparent display device for the two-side display.

2. The intelligent eyewear of claim 1, wherein the processor is configured to generate the processed result in a form of graphic and textual information.

3. The intelligent eyewear of claim 1, wherein for each eyeglass, the transparent display device comprises a display device with two display surfaces, which are configured for front-face display and back-face display respectively.

4. The intelligent eyewear of claim 1, wherein for each eyeglass, the transparent display device comprises two display devices, each of which comprises one display surface, and the two display devices are configured for front-face display and back-face display respectively.

5. The intelligent eyewear of claim 1, wherein the transparent display device comprises a flexible display device.

6. The intelligent eyewear of claim 1, further comprising an analysis memory which is connected with the processor and has at least one of following databases stored therein: a database comprising a correspondence relationship between the brainwave signal and content indicated by the brainwave signal, a database comprising a correspondence relationship between the gesture instruction and content indicated by the gesture instruction, and a database comprising a correspondence relationship between the voice signal and content indicated by the voice signal.

7. The intelligent eyewear of claim 1, further comprising a positioning system, wherein the camera is further configured to acquire environmental information of surroundings of the intelligent eyewear and send the environmental information to the processor, and the processor is further configured to determine a current location according to the environmental information the camera sends in combination with the positioning system.

8. The intelligent eyewear of claim 1, wherein the acoustic pickup is disposed at a position where a nose pad of the eyeglass frame is located, the brainwave recognizer is disposed in a middle of the leg, and the processor is disposed at a tail end of the leg.

9. The intelligent eyewear of claim 7, wherein the positioning system comprises a distance meter disposed on the leg and configured to sense a distance between the current location and a target location and send sensed data to the processor.

10. The intelligent eyewear of any claim 1, wherein the leg is further provided with a charging device, which is configured for charging at least one of the transparent display device, the camera, the acoustic pickup, the brainwave recognizer and the processor.

11. The intelligent eyewear of claim 10, wherein the charging device comprises a solar charging device which is integrated on a surface of the transparent display device.

12. The intelligent eyewear of claim 9, wherein the distance meter is one selected from the group consisting of an ultrasonic range finder, an infrared distancer and a laser range finder.

13. A control method for an intelligent eyewear, wherein the intelligent eyewear comprises an eyeglass, an eyeglass frame and a leg;
the eyeglass comprises a transparent display device configured to perform two-side display;
the eyeglass frame is provided with a camera and an acoustic pickup, which are configured to acquire a gesture instruction and a voice signal and convert them into a gesture signal and an audio signal respectively; and
the leg is provided with a brainwave recognizer and a processor, the brainwave recognizer is configured to acquire a brainwave signal of a wearer, and the processor is configured to receive and process the gesture signal, the audio signal and the brainwave signal and send a processed result to the transparent display device for the two-side display; and
the control method comprises a receiving mode and an expression mode which are configured to be performed one after another, simultaneously or independently, wherein the receiving mode comprises:
S1.1 by means of the camera and the acoustic pickup, acquiring the gesture instruction and the voice signal of a communicatee, converting the gesture instruction and the voice signal into the gesture signal and the audio signal and sending the gesture signal and the audio signal to the processor; and
S1.2 by means of the processor, recognizing and reading the audio signal and the gesture signal separately to convert the audio signal and the gesture signal into graphic and textual information, and performing back-face display through the eyeglass to display the information to the wearer; and
the expression mode comprises:
S2.1 by means of the brainwave recognizer, acquiring the brainwave signal of the wearer, obtaining a first information by encoding and decoding the brainwave signal, and sending the first information to the processor; and
S2.2 by means of the processor, converting the first information into graphic and textual information, and performing front-face display through the eyeglass to display the graphic and the textual information to the communicatee.

14. The control method of claim 13, wherein the step S1.2 comprises: by means of the processor, performing searching and matching of the received gesture and audio signals in a database with a correspondence relationship between the gesture signal and content indicated by the gesture signal stored therein and in a database with a correspondence relationship between the audio signal and content indicated by the audio signal stored therein, and outputting indicated contents in a form of graph and text.

15. The control method of claim 13, wherein if the step S2.1 fails to acquire the brainwave signal, the method further comprises:
reminding an occurrence of an error through the back-face display of the eyeglass.

16. The control method of claim 13, wherein the step S2.2 comprises: by means of the processor, performing searching and matching of the received first information in a database with a correspondence relationship between the brainwave information and content indicated by the brainwave information stored therein, and outputting indicated content in a form of graph and text.

17. The control method of claim 13, wherein before performing the front-face display, the step S2.2 further comprises:
performing back-face display for the graphic and textual information, and then performing the front-face display for the graphic and textual information after receiving a brainwave signal indicating acknowledgement from the wearer.

18. The control method of claim 13, in the step S1.1, the audio signal is obtained by performing analog-to-digital conversion for the acquired voice signal through the acoustic pickup.

19. The control method of claim 13, wherein in the step S1.1, information of an ambient environment for the intelligent eyewear is also acquired by the camera at a same time as the gesture signal and the audio signal are acquired, and is used to determine a current location in combination with a positioning system connected with the processor.

20. The control method of claim 19, wherein calculation of and comparison between the information of the ambient environment acquired by the camera and location information stored in the positioning system are performed by the processor.
